(19) United States
(12) Patent Application Publication
(10) Pub. No.: US 2005/0101829 A1
(43) Pub. Date: May 12, 2005

(54) Delayed intensity light for infant care apparatus

(76) Inventors: Michael H. Mackin, Ellicott City, MD (US); Matthew L. Severns, Gaithersburg, MD (US)

Correspondence Address: ROGER M. RATHBUN, 13 MARGARITA COURT, HILTON HEAD ISLAND, SC, 29926, US

(21) Appl. No.: 10/703,380

(22) Filed: Nov. 7, 2003

(51) Int. Cl. A61G 11/00

(52) U.S. Cl. 600/22; 607/100

(57) ABSTRACT

An infant care apparatus for supporting an infant upon an infant platform having a procedure light that is adapted to direct light onto the infant resting on the infant platform. There is a electrical circuit that is activated by the user turning on the procedure light whereupon the electrical circuit prevents the immediate full intensity of the procedure light from impinging upon the infant but starts the intensity of the procedure light at a low level and then increases the intensity of the light emanating from the procedure light over a period of time to a desired intensity. By the gradual increase of intensity, the infant is not startled by the sudden onset of a high intensity beam of light.

### BACKGROUND

The present invention relates to an infant care apparatus and, more particularly, to a procedure light used with an infant care apparatus that, upon activation, reaches full intensity over a controlled period of time.

In the care of newborn infants, there is an infant warmer apparatus that is used to provide warming of the infant and to supply the necessary heat to maintain the infant at a predetermined temperature. The infant warmer basically comprises a planar surface on which the infant is positioned and which planar surface normal includes side guards to keep the infant safely within the confines of the apparatus.

Infant warmers also have a overhead radiant heater that is located above the infant and which thus radiates energy in the infrared spectrum to impinge upon the infant to maintain the infant at the desired temperature. With infant warmers, since the infant is otherwise totally exposed to the surroundings, there is almost unlimited access to the infant by the attending personnel to perform various procedures on that infant. A typical infant warmer is shown and described in U.S. Pat. No. 5,474,517 of Falk et al as prior art to that patent.

Since there is such wide open access to the infant, the infant warmer is used where there is some intervention or procedure to be carried out on the infant while resting on the planar surface. Since some, if not all, of such procedures are delicate, it is normally necessary to have some source of illumination of the infant so that the attending personnel can have sufficient light to view the infant in carrying out the particular procedure. Such procedure lights are, of necessity, designed to provide a relatively bright intensity so that the caregiver can adequately see to perform the procedure on the infant.

One of the difficulties, or drawbacks, with the use of such procedure lights, however, is that the bright light must be directed toward the infant in order to provide its intended purpose and, therefore, when the light is turned on, that bright illumination immediately reaches the infant and causes a startling reflex, that is, the sudden incidence of bright light creates a stress in an infant that is normally already under stressed conditions.

Accordingly, it would be advantageous to have a procedure light that does not suddenly shine a bright, full intensity, onto the infant when it is turned on but which, upon activation, increases the level of the intensity at a slow, controlled rate by a circuitry so that the infant is not startled by the immediate onset of the high intensity light.

### SUMMARY OF THE INVENTION

Accordingly, the present invention relates to an infant care apparatus, such as an infant warmer, that has a procedure light that is adapted to direct a relatively high intensity of light onto the infant and wherein that light is automatically controlled such that, upon activation, the light is initially started at a low level and the intensity of the light is steadily increased at a controlled rate up to the point where the full intensity is reached.

Thus with the present infant care apparatus, the procedure light can be turned on by a simple activation of a switch by the caregiver as is normal, but the circuitry prevents the procedure light from immediately reaching its full intensity. Instead, an electrical circuit is provided that automatically brings the light up to its full intensity at a gradual, predetermined rate so that the activation of the light does not immediately produce the full intensity that could startle the infant.

These and other features and advantages of the present invention will become more readily apparent during the following detailed description taken in conjunction with the drawings herein.

### BRIEF DESCRIPTION OF THE DRAWINGS

FIG. 1 is a perspective view of an infant warming apparatus having a procedure light that is usable in accordance with the present invention;

FIG. 2 is a circuit diagram of a electrical circuit that can be used to carry out the present invention, and

FIG. 3 is a schematic view illustrating electrical pulse widths that are produced in utilizing the circuit of FIG. 2.

### DETAILED DESCRIPTION OF THE INVENTION

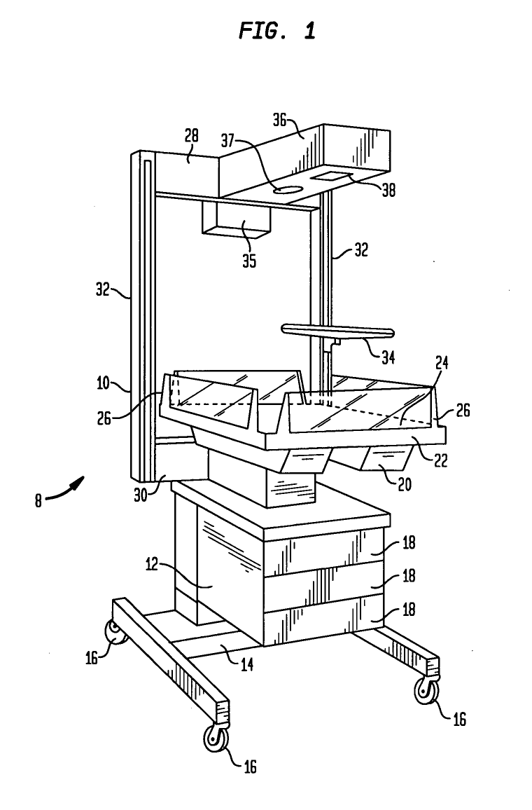

Referring now to FIG. 1, there is shown a perspective view of an infant warmer 8 constructed in accordance with the present invention. It should be noted that the present invention is described specifically with respect to an infant warmer, however, the present invention is equally applicable to other infant care apparatus that supports an infant for treatment of that infant and where there is a light used to illuminate the infant. As shown, the infant warmer 8 includes a frame 10 which provides a free standing unit for the infant warmer 8. The frame 10 is support upon a cabinet 12 which, in turn, is mounted upon a base 14 having wheels 16 so that the infant warmer 8 is easily movable. The cabinet 12 may also include one or more drawers 18 for containing items for attending to the infant.

An infant platform 20 is mounted atop of the cabinet 12 and on which is located an infant bed 22 which underlies and supports an infant positioned thereon. Infant platform 20 is the main support for the infant bed 22. The infant bed 22 has a generally planar upper surface 24 with appropriate cushioning material for comfort of the infant and further may be surrounded by guards 26, generally of a clear plastic material that contain the infant on the upper surface 24. Normally, the guards 26 are removable and/or releasable for complete access to the infant.

Frame 10 includes upper and lower cross members 28 and 30, respectively, joining a pair of vertical struts 32 and which vertical struts 32 may provide a means of support for other structural components such as a shelf 34.

Mounted on the upper cross member 28 may be a control module 35 that is conveniently positioned intermediate the vertical struts 32 and can include displays of various monitored parameters as well as include the various controls for operation of the functions of the infant warming apparatus 10. In addition, there is an overhead housing 36 mounted to the upper cross member 28 and which contains a radiant heater 37 that directs infrared energy toward an infant lying on the infant bed 22 in order to provide warmth to the infant.

As also can be seen in FIG. I there is a procedure light 38 that is recessed into and integrally mounted in the overhead housing 36 and which is constructed and affixed to the overhead housing 36.

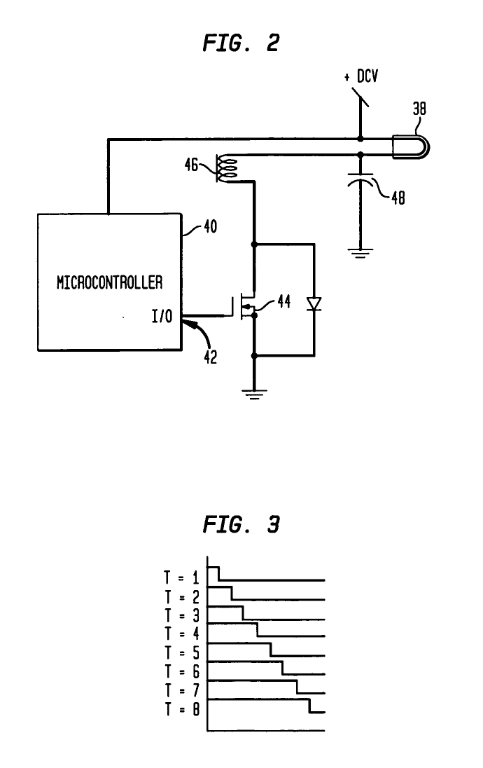

Turning now to FIG. 2, taken along with FIG. 1, there is a circuit diagram of a electrical circuit that can be used in carrying out the present invention, it being noted that there are many differing circuits that can be used to achieve the objectives of the present invention other than the particular circuit illustrated and described herein to carry out the invention. For example, the control of the procedure light 38 intensity could be carried out by means of an analog circuit, such as a motor controlled rheostat or other electrical system or circuit.

As such, in FIG. 2, there is a electrical circuit having a microcontroller 40. The microcontroller 40 can be activated by means of a switch located on the infant warmer 8 that can be simply turned on by the caregiver to illuminate the procedure light 38. By such means, the caregiver puts the present invention into action by the use of a normal switch that can be a conventional switch. When the switch is activated, the microcontroller 40 begins to output a series of pulses of increasing length at the I/O port 42. Those pulses occur at a repetition frequency much higher than can be heard by the human ear and typically well above 20 kHz. Those pulses turn on an FET 44 for increasing periods of time in each cycle such that the on pulses gradually increase in length for each cycle.

Those pulses generated by the FET 44 are smoothed by an inductor 46 and capacitor 48 to minimize the electromagnetic interference (EMI) generated by the circuit. As such, as the pulses get longer, the power applied to the procedure light 38 increases. Thus, the microcontroller 40 can be programmed to increase the pulse lengths at a predetermined rate such that the intensity of the procedure light can commence upon activation, at a low level of illumination and progressively increase the intensity at a predetermined rate over a predetermined period of time until the procedure light 38 reaches its desired intensity. In normal use, the desired intensity will be the maximum rated intensity of the particular procedure light.

Turning to FIG. 3, there is shown a schematic view of a pattern of pulse widths that can be programmed and adjusted to different time courses of the turn on period of the procedure light 38. As can be seen, the repetition times of the pulses are plotted along the y axis with the pulse lengths shown along the x axis. As can be seen, the pulse widths increase over the passage of time from T=1 to T=8 and the actual amount of time to bring the procedure light 38 to full desired intensity can, therefore, be adjusted in accordance with the desired turn on time and rate of the increasing intensity.

A strictly linear increase in pulse width, as show in FIG. 3, will not cause the procedure light 38 to turn on with uniformly increasing intensity due to the highly non-linear relationship between supply voltage and light output for incandescent bulbs. However, as indicated, the rate at which the pulse widths increase can be adjusted to achieve a linear effect or other desired effect.

As stated, the electrical circuit suitable for use in carrying out the present invention can be any one of many other circuits that are capable of carrying out the progressive increase of the intensity for the procedure light for an infant care apparatus. In addition, with an infant care apparatus, there may also be another on-off switch for the procedure light 38 that bypasses the electrical circuit of FIG. 2 in the event of an emergency and the caregiver wants to immediately turn on the procedure light to full intensity.

Otherwise, the present circuit, or alternative circuit, prevents the user from immediately turning the procedure light on to its full intensity so that, in the normal use of the present invention, when the user activates the present procedure light, the procedure light is not immediately turned on to the high intensity that could startle and infant being cared for in the infant care apparatus, but gradually increases from a low intensity to a desired high intensity over a predetermined period of time.

Those skilled in the art will readily recognize numerous adaptations and modifications which can be made to the infant care apparatus of the present invention which will result in an improved control for a procedure light for an infant care apparatus, yet all of which will fall within the scope and spirit of the present invention as defined in the following claims. Accordingly, the invention is to be limited only by the following claims and their equivalents.

1. An infant care apparatus, said infant care apparatus comprising a base having an infant platform on which an infant is adapted to be positioned, a procedure light having a maximum rated intensity affixed to said infant care apparatus and positioned to direct a beam of light toward the infant platform, a switch to activate said procedure light, an electrical circuit adapted to respond to the activation of said procedure light by said switch to prevent the procedure light from immediately reaching maximum intensity, said electrical circuit adapted to turn on said procedure light at an intensity lower than the maximum intensity and to increase the intensity of the procedure light by increasing the power to the procedure light by means of a microcontroller at a controlled rate over a predetermined period of time up to a desired intensity of said procedure light:

2. The infant care apparatus as defined in claim 1 wherein said desired intensity is the maximum intensity of the procedure light.

3. The infant care apparatus as defined in claim 1 wherein the microcontroller produces electrical pulses at a predetermined frequency and predetermined pulse widths.

4. The infant care apparatus as defined in claim 3 wherein the electrical circuit produces electrical pulses at a predetermined frequency that is above the audible range of the human ear.

5. The infant care apparatus as defined in claim 1 wherein the microcontroller, upon activation, produces pulses of increasing pulse widths over a predetermined time period.

6. The infant care apparatus as defined in claim 1 wherein the infant care apparatus is an infant warmer.

7. A method of controlling the intensity of light directed toward an infant platform of an infant care apparatus, said method comprising the steps of:
providing an infant care apparatus having an infant platform adapted to support an infant;
providing a procedure light having a maximum rated intensity mounted to direct a beam of light onto the infant platform;
activating the procedure light to cause light to be directed therefrom at an intensity lower than said maximum intensity;
providing an electrical circuit that is energized upon the activation of the procedure light to increase the intensity of the light from the procedure light by increasing the power to the procedure light by means of a microcontroller over a period of time until a predetermined intensity has been reached.

8. The method as defined in claim 7 wherein the step of providing an electrical circuit comprises providing an electrical circuit wherein the microcontroller produces electrical pulses to said procedure light at a predetermined frequency and having predetermined pulse widths.

9. The method as defined in claim 8 wherein the step of providing an electrical circuit comprises providing an electrical circuit having a microcontroller producing electrical pulses at a predetermined frequency above the audible range of a human ear.

10. The method as defined in claim 8 wherein the step of providing an electrical circuit having a microcontroller comprises providing a microcontroller adapted to provide timed electrical pulses at increasing pulse widths.

11. The method as defined in claim 8 wherein the step of providing an infant care apparatus comprise providing an infant warmer.
